(19) United States
(12) Patent Application Publication
(10) Pub. No.: US 2017/0308562 A1
(43) Pub. Date: Oct. 26, 2017

(54) System and Method for Multi-Master Synchronous Replication Optimization

(71) Applicant: Huawei Technologies Co., Ltd., Shenzhen (CN)

(72) Inventors: Nirmala Sreekantaiah, Bangalore (IN); Prasanna Venkatesh Ramamurthi, Bangalore (IN); Dilip Kumar, Shenzhen (CN)

(21) Appl. No.: 15/646,840

(22) Filed: Jul. 11, 2017

Related U.S. Application Data
(63) Continuation of application No. PCT/CN2016/106420, filed on Nov. 18, 2016.

(30) Foreign Application Priority Data
Apr. 6, 2016 (IN) IN201641012171

(51) Int. Cl. G06F 17/30

(52) U.S. Cl. CPC G06F 17/30351; G06F 17/30575

(57) ABSTRACT

A system and method for multi-master synchronous replication optimization, which comprises one device in a system is chosen as insert leader during insert. The insert leader allocates a range of rows (row_ids) to the incoming queries. If the query inserts more records than the range, it is rolled back. During the commit, the row_id range and the new records are sent to other masters for conflict checking. The present disclosure scalability and a throughput of the system is increased because of optimistic concurrency based replication.

### CROSS-REFERENCE TO RELATED APPLICATION

This application is a continuation of International Application No. PCT/CN2016/106420, filed on Nov. 18, 2016, which claims priority to Indian Patent Application No. IN201641012171, filed on Apr. 6, 2016. The disclosures of the aforementioned applications are hereby incorporated by reference in their entireties.

### TECHNICAL FIELD

The present subject matter described herein, in general, relates to storage of data in databases or distributed computing systems, and more particularly, to a system and method for multi-master synchronous replication optimization.

### BACKGROUND

A database is an electronic filing system that stores data in a structured way. The primary storage structure in a database is a table. A database may contain multiple tables and each table may hold information of a specific type. Database tables store and organize data in horizontal rows and vertical columns. Rows typically correspond to real-world entities or relationships that represent individual records in a table. Columns may denote specific attributes of those entities or relationships, such as “name,” “address” or “phone number.” For example, Company X may have a database containing a “customer” table listing the names, addresses and phone numbers of its customers. Each row may represent a single customer and the columns may represent each customer's name, address and phone number.

Database replication is a process of ensuring a copy of data exists on a different machine to provide high availability. Database replication is generally the frequent electronic copying data from a database in one computer or server to a database in another so that all users share the same level of information.

As well known in the prior-art, the replication can either be physical (log-shipping) or logical (command-shipping). It can also be synchronous, where in the application wait time includes changes in the originator node and time to safely commit in the replica, or it can be asynchronous, where application gets response immediately after the data is safely committed in the originator node. The replicas are generally read-only. Further, master-master replication is a deployment scenario where-in both nodes can accept write queries. Also, it can be understood that, an originator node is always a single node however there can be multiple replica nodes.

Conventionally available techniques generally work by applying the changes to queries received on the originator node, sending these changes to the replica, waiting for these changes to be committed on the replica nodes, and then commit the changes in originator node. However, a conflict resolution for the transactions that are received from the replica node and the ones that are happening in the current node is the main challenge of multi-master synchronous replication. Conflict resolution is a way to handle different types of conflicts, such as update conflicts (two transactions update same row at same time), uniqueness constraint conflicts (two transactions try to update/insert same unique key in the table), deletion conflicts (deletion of a row by one transaction and updating/deletion of the same by another transaction). For a master-master replication, during update on the nodes (other than the originator node), locks are obtained on the record to check if there is a conflict. These locks are held until the transaction is committed or rolled-back. This kind of locking reduces the scalability and throughput of the overall system.

### SUMMARY

This summary is provided to introduce concepts related to system and method for multi-master synchronous replication optimization which is further described below in the detailed description. This summary is not intended to identify essential features of the claimed subject matter nor is it intended for use in determining or limiting the scope of the claimed subject matter.

A main objective of the present disclosure is to solve the technical problem as recited above by providing a system and method for optimizing multi-master synchronous replication.

Another objective of the present disclosure is to increase the scalability and throughput of the system in case of multi-master synchronous replication. The present disclosure considers an availability of a flow controller at the application level which will route the distinct range of queries to different masters based on the application logic.

Another objective of the present disclosure is to provide a system and method that uses optimistic concurrency based replication to achieve improved scalability and throughput of the system.

In one embodiment, a system for multi-master replication is disclosed. The system comprises at least one first master device and a first database at a first replication site, and at least one second master device and a second database at a second replication site. The first master device having the first database at a first replication site, is configured to receive at least one query, allocate at least a row to insert atleast one record present in the query received, the row is allocated on basis of a row identification (row_id), determine if the record to insert exceeds the row allocated, roll back, if exceeds, the insert, or transmit, during commit, the row_id and the record present in the query received to second master device for conflict check. The second master device having the second database at a second replication site is configured to receive the row_id and the record present in the query, check a conflict based on the row_id received with at least a row in the second database. If conflict is detected, the commit fails and an error is displayed, or if the record to insert does not exceed the row allocated and conflict is not detected, the record is applied at the first database and the second database simultaneously.

In one embodiment, a system for multi-master replication is disclosed. The system comprises at least one first master device having a first database at a first replication site, and configured to receive at least one query, allocate at least a row to insert at least one record present in the query received, the row is allocated on basis of a row_id, determine if the record to insert exceeds the row allocated, roll back, if exceeds, the insert, or transmit, to commit, the row_id and the record present in the query received to at least one second master device and a second database at a second replication site for conflict check.

In one embodiment, a system for multi-master replication is disclosed. The system comprises at least one second master device having a second database at a second replication site, and configured to receive at least a row_id of a row and a record present in the query from at least one first master device, check a conflict based on the row_id received with at least a row in the second database, wherein if the conflict is detected, the commit fails and an error is displayed, or if the conflict is not detected, the record is applied at a first database residing at the first master device and the second database simultaneously.

In one embodiment, a method for multi-master replication is disclosed. The method comprises receiving at least one query, allocating at least a row to insert at least one record present in the query received, the row is allocated on basis of a row_id, determining if the record to insert exceeds the row allocated, roll back, if exceeds, the insert, or transmitting the row_id and the record present in the query received to at least one device for conflict check.

In contrast to the prior-art techniques, available if any, the present disclosure instead of using a pessimistic approach, the replicated records can be updated optimistically. In present disclosure no locks are obtained during actual operation. The actual conflict checking happens during the commit on the master side. So even though query succeeds in originator node, it can fail during commit.

Further, the present disclosure, during insert, one of the masters will be chosen as insert leader. The insert leader will allocate a range of row_id to the incoming query. If the query inserts more records than the range, it will be rolled back. During commit, the row_id range and the new records are sent to other replicas for conflict checking. The present disclosure is true for update query, wherein row_id can change for insert across different replicas.

The various options and preferred embodiments referred to above in relation to the first embodiment are also applicable in relation to the other embodiments.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a system for multi-master replication, in accordance with an embodiment of the present subject matter.

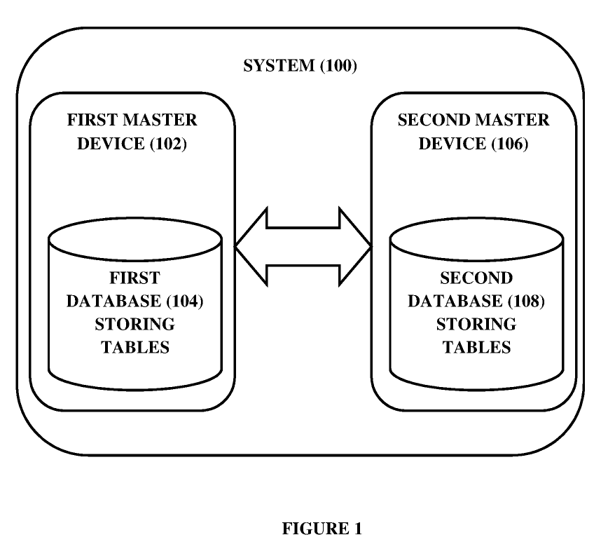

FIG. 2 illustrates a block diagram for database replication, in accordance with an embodiment of the present subject matter.

FIG. 3 illustrates a method for multi-master replication, in accordance with an embodiment of the present subject matter.

It is to be understood that the attached drawings are for purposes of illustrating the concepts of the disclosure and may not be to scale.

### DETAILED DESCRIPTION OF THE PRESENT DISCLOSURE

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In the following description, for the purpose of explanation, numerous specific details are set forth in order to provide a thorough understanding of the present disclosure. It will be apparent, however, that the present disclosure may be practiced without these specific details. In other instances, well-known structures and devices are shown in block diagram form in order to avoid unnecessarily obscuring the present disclosure.

While aspects are described for system and method for multi-master synchronous replication optimization, the present disclosure may be implemented in any number of different computing systems, environments, and/or configurations, the embodiments are described in the context of the following exemplary systems, apparatus, and methods.

In one embodiment, the present disclosure instead of using a pessimistic approach, the replicated records can be updated optimistically. The present disclosure does not use any locks i.e., locks are not obtained, during actual operation. Actual conflict checking happens during the commit on the replica side. So even though query succeeds in the originator node, it may fail during commit.

The present disclosure is also applicable for update query, whereas row_id may change for insert across different masters. During insert, one of the masters may be chosen as an insert leader. The insert leader may allocate a range of row_ids to the incoming query. If the query inserts more records than the range, it will be rolled back. During commit, the row id range and the new records are sent to other replica for conflict checking.

In one embodiment, as compared to the existing replication operations, in the present disclosure, when a log is sent for the replication, it contains row_id of the record with the updated data. The row_id may be treated as a physical offset of the record from the 0th record of the table. Whenever the logs for a row_id are received, that row_id is marked as dirty, and update for the record corresponding to the row id is started. This update can be atomic operation and does not need any locks.

In one embodiment, as compared to the existing operations during update on the node, in the present disclosure, during an update operation on the node, row_id of the specific record is marked as dirty. This may be an atomic operation. If the row_id is marked dirty already due to the replica update, the current update operation may fail at this stage. If the update of the record, in the current node succeeds, conflict resolution is moved to the commit time,

In one embodiment, as compared to the existing operations during commit, in the present disclosure, during commit of each transaction, a message is sent to all the replicas. Each of the replica checks for the conflict based row_id of the log sent by replica, and row_id of its current transactions in progress. If there is a conflict, they return an error to the originator node, and the transaction fails. If there is no conflict, both originator and the replica nodes apply the records in parallel. User may have to wait only till the record is applied in originator node as there may be no more conflicts in the replicas.

Referring now to FIG. 11 a system for multi-master replication is illustrated, in accordance with an embodiment of the present subject matter. In one implantation, the system 100 comprises plurality of master devices storing replicated data and communicably coupled with each other. The system 100 for multi-master replication is comprises at least one first master device 102 and a first database 104 at a first replication site, and at least one second master device 106 and a second database 108 at a second replication site. Although the present subject matter is explained considering that the present disclosure is implemented in the first master device 102 and/or the second master device 106, it may be understood that the first master device 102 and/or the second master device 106 may also be implemented in a variety of computing systems, such as a laptop computer, a desktop computer, a notebook, a workstation, a mainframe computer, a server, a network server, and the like. The first master device 102 and/or the second master device 106 may be accessed by multiple users, or applications residing on the first master device 102 and/or the second master device 106. Examples of the first master device 102 and/or the second master device 106 may include, but are not limited to, a portable computer (computer system), a personal digital assistant, a handheld device, sensors, routers, gateways and a workstation. The first master device 102 and/or the second master device 106 is communicatively coupled to each other or other devices or nodes or apparatuses to form a network (not shown).

In one embodiment, the network (not shown) may be a wireless network, a wired network or a combination thereof. The network can be implemented as one of the different types of networks, such as Global System for Mobile communication (GSM), Code Division Multiple Access (CDMA), Long Term Evolution (LTE), Universal Mobile Telecommunications System (UMTS), intranet, local area network (LAN), wide area network (WAN), the Internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

The first master device 102 and/or the second master device 106 as illustrated in accordance with an embodiment of the present subject matter may include a processor (not shown), an interface (not shown), and a memory (not shown). The processor may be implemented as one or more microprocessors, microcomputers, microcontrollers, digital signal processors, central processing units, state machines, logic circuitries, and/or any devices that manipulate signals based on operational instructions. Among other capabilities, the at least one processor is configured to fetch and execute computer-readable instructions or modules stored in the memory.

The input/output interface (I/O interface) may include a variety of software and hardware interfaces, for example, a web interface, a graphical user interface, and the like. The I/O interface may allow the first master device 102 and/or the second master device 106 to interact with a user directly. Further, the I/O interface may enable the first master device 102 and/or the second master device 106 to communicate with other devices or nodes, computing devices, such as web servers and external data servers (not shown). The I/O interface can facilitate multiple communications within a wide variety of networks and protocol types, including wired networks, for example, GSM, CDMA, LAN, cable, etc., and wireless networks, such as WLAN, cellular, or satellite. The I/O interface may include one or more ports for connecting a number of devices to one another or to another server. The I/O interface may provide interaction between the user and the first master device 102 and/or the second master device 106 via, a screen provided for the interface.

The memory may include any computer-readable medium known in the art including, for example, volatile memory, such as static random access memory (SRAM) and dynamic random access memory (DRAM), and/or non-volatile random access memory (NVRAM), such as read-only memory (ROM), erasable programmable ROM, flash memories, hard disks, optical disks, and magnetic tapes. The memory may include plurality of instructions or modules or applications to perform various functionalities. The memory includes routines, programs, objects, components, data structures, etc., which perform particular tasks or implement particular abstract data types.

In one embodiment, a system 100 for multi-master replication is disclosed. The system 100 comprises at least one first master device 102 and a first database 104 at a first replication site, and at least one second master device 106 and a second database 108 at a second replication site. The first master device 102 having the first database 104 at a first replication site, is configured to receive at least one query, allocate at least a row to insert at least one record present in the query received, the row is allocated on basis of a row_id, determine if the record to insert exceeds the row allocated. roll back, if exceeds, the insert, or transmit, during commit, the row_id and the record present in the query received to second master device for conflict check. The second master device 106 having the second database 108 at a second replication site, is configured to receive the row_id and the record present in the query, check a conflict based on the row_id received with at least a row in the second database. If the conflict is detected, the commit fails and an error is displayed, or if the conflict is not detected, the record is applied at the first database and the second database simultaneously.

In one embodiment, a system 100 for multi-master replication is disclosed. The system 100 comprises at least one first master device 102 having a first database 104 at a first replication site, and configured to receive at least one query, allocate at least a row to insert at least one record present in the query received, the row is allocated on basis of a row_id, determine if the record to insert exceeds the row allocated, roll back, if exceeds, the insert, or transmit, to commit, the row_id and the record present in the query received to at least one second master device and a second database at a second replication site for conflict check.

In one embodiment, a system 100 for multi-master replication is disclosed. The system 100 comprises at least one second master device 106 having a second database 108 at a second replication site, and configured to receive at least a row_id of a row and a record present in the query from at least one first master device, check a conflict based on the row_id received with at least a row in the second database, wherein if the conflict is detected, the commit fails and an error is displayed, or if the conflict is not detected, the record is applied at a first database residing at the first master device and the second database simultaneously.

In one embodiment, whenever logs for a row_id are received, that row_id is marked as dirty, and update for the next record is started. This update may be an atomic operation and does not need any locks.

In one embodiment, during an update operation on the node, row_id of the specific record is marked as dirty. If the row_id is marked dirty already due to the replica update, the current update operation fails at this stage. If the update of the record, in the current node succeeds, conflict resolution is moved to the commit time.

In one embodiment, upon updating the next record in the row, moving at least a conflict resolution to commit.

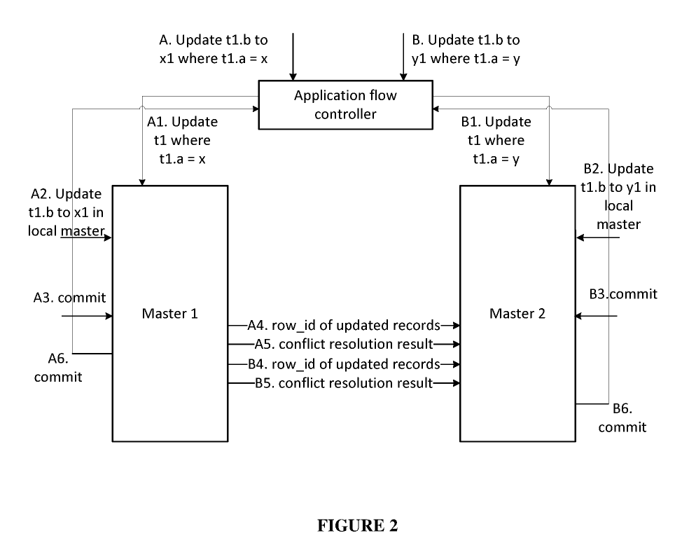

Referring now to FIG. 2, a block diagram for database replication is illustrated, in accordance with an embodiment of the present subject matter. Consider two update queries (A, B) at application. An application flow controller, upon receipt of these queries, may realize that the queries are updating distinct ranges, even though they update the same table t1, and sends query A to Master1 and query B to Master2. The Master1 upon receiving query (A1), creates an empty write set, updates the table locally (A2), populates the write set and tries to commit (A3). During commit, it sends write set containing row_ids of the updated records to other masters (Master2 in this case). The Master2 upon the receipt of message from Master1, checks if there is any conflict for the records in a local storage on Master2, and sends the conflict resolution result to the originator node (Master1) as A5, If there is no conflict, the row is committed in Master2 before sending A5. Based on the results of conflict check, Master1 goes ahead and commits the records (A6). Similar operations are done for other update (B) with Master2 being the originator node and Master1 as the replica.

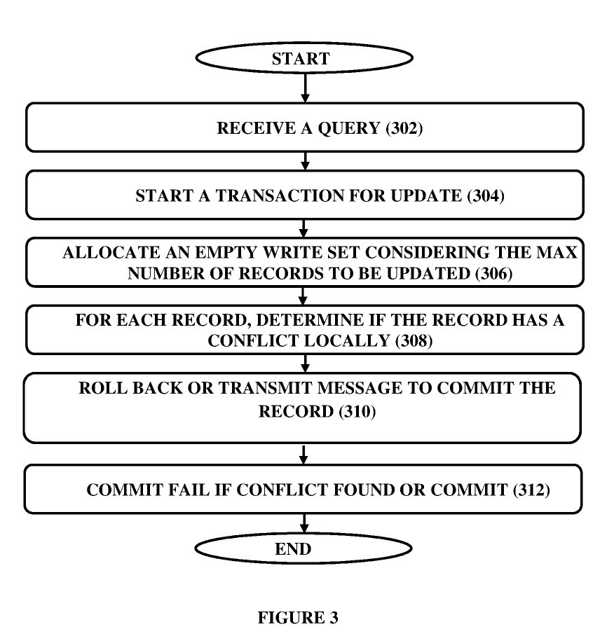

FIG. 3 illustrates a method for multi-master replication, in accordance with an embodiment of the present subject matter. The method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method is described is not intended to be construed as a limitation, and any number of the described method blocks can be combined in any order to implement the method or alternate methods. Additionally, individual blocks may be deleted from the method without departing from the protection scope of the subject matter described herein. Furthermore, the method can be implemented in any suitable hardware, software, firmware, or combination thereof. However, for ease of explanation, in the embodiments described below, the method may be considered to be implemented in the above described system 100.

In one embodiment, method for multi-master replication is disclosed.

At block 302, the present disclosure receives at least one query instructing the insertion/update of a record in a particular row of the database.

At block 304, the present disclosure initiates/starts a transaction for the query received.

At block 306, an empty write set considering a maximum number of records to be updated is allocated for the transaction.

At block 308, the present disclosure determines if the record to be updated has a conflict.

In one embodiment, whenever a row has to be updated, that row_id is marked as dirty, and update for the next record is started. This update may be atomic operation and may not need any locks.

In one embodiment, during an update operation on the node, row_id of the specific record is marked as dirty. This again can be atomic operation. If the row_id is marked dirty already due to the replica update, the current update operation fails at this stage. If the update of the record, in the current node succeeds, conflict resolution is moved to the commit time.

At block 310, the transaction is rolled back or information is transmitted to other replicas based on results in 308.

At block 312, if the conflict detected from other replicas, the commit fails and an error is displayed, or if the conflict is not detected, the records are committed.

In one embodiment, the method is a row (row_id) based multi-master replication.

Apart from what is explained above, the present disclosure also includes advantages such as increased scalability and throughput of the system because of optimistic concurrency based replication, and provides a row id based multi master replication.

A person skilled in the art may understand that any known or new algorithms by be used for the embodiment of the present disclosure. However, it is to be noted that, the present disclosure provides a method to be used during back up operation to achieve the above mentioned benefits and technical advancement irrespective of using any known or new algorithms.

A person of ordinary skill in the art may be aware that in combination with the examples described in the embodiments disclosed in this specification, units and algorithm steps may be implemented by electronic hardware, or a combination of computer software and electronic hardware. Whether the functions are performed by hardware or software depends on the particular applications and design constraint conditions of the technical solution. A person skilled in the art may use different methods to implement the described functions for each particular application, but it should not be considered that the embodiment goes beyond the scope of the present disclosure.

It may be clearly understood by a person skilled in the art that for the purpose of convenient and brief description, for a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the unit division is merely logical function division and may be other division in actual embodiment. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

When the functions are implemented in a form of a software functional unit and sold or used as an independent product, the functions may be stored in a computer-readable storage medium. Based on such an understanding, the technical solutions of the present disclosure essentially, or the part contributing to the prior art, or a part of the technical solutions may be implemented in a form of a software product. The computer software product is stored in a storage medium, and includes several instructions for instructing a computer device (which may be a personal computer, a server, or a network device) to perform all or a part of the steps of the methods described in the embodiment of the present disclosure. The foregoing storage medium includes any medium that can store program code, such as a universal serial bus (USB) flash drive, a removable hard disk, a ROM, a random access memory (RAM), a magnetic disk, or an optical disc.

Although embodiments for system and method for multi-master synchronous replication optimization have been described in language specific to structural features and/or methods, it is to be understood that the appended claims are not necessarily limited to the specific features or methods described. Rather, the specific features and methods are disclosed as examples of embodiments of the system and method for multi-master synchronous replication optimization.

What is claimed is:

1. A system for multi-master replication, comprising:
at least one first master device at a first replication site;
a first database at the first replication site;
at least one second master device at a second replication site; and
a second database at the second replication site;
wherein the at least one first master device has the first database at the first replication site,
wherein the at least one first master device is configured to:
receive at least one query;
allocate at least a row to insert at least one record present in the query received based on a row_id;
roll back the insert of the at least one record when the record to insert exceeds the row allocated; and
transmit the row_id and the record present in the query received to the second master device for a conflict check during commit when the record to insert does not exceed the row allocated, and
wherein the second master device has the second database at the second replication site,
wherein the second master device is configured to:
receive the row_id and the record present in the query; and
check a conflict based on the row_id received with at least a row in the second database,
wherein the commit fails and an error is displayed if the conflict is detected, and
wherein the record is applied at the first database and the second database simultaneously if the conflict is not detected.

2. The system as claimed in claim 1, wherein on receipt of the row to insert the record present in the query received, at least one of the first master device or the second master device is configured to:
mark the row dirty; and
update the next record received in the query when the row is marked dirty.

3. The system as claimed in claim 2, wherein at least one of the the at least one first master device or the second master device is further configured to:
detect the row based on the row_id for updating the next record; and
check whether the row is marked dirty, wherein the row is marked dirty by at least a replica update, and wherein updating the next record is failed when the row is marked dirty, and
update the next record in the row when the row is not marked dirty.

4. The system as claimed in claim 3, wherein upon updating the next record in the row, moving at least a conflict resolution to commit.

5. A system for multi-master replication, comprising:
at least one first master device having a first database at a first replication site, wherein the at least one first master device configured to:
receive at least one query;
allocate at least a row to insert at least one record present in the query received based on a row_id;
roll back the insert of the at least one record when the record to insert exceeds the row allocated; and
transmit the row_id and the record present in the query received to at least one second master device and a second database at a second replication site for a conflict check during commit when the record to insert does not exceed the row allocated.

6. The system as claimed in claim 5, wherein on receipt of the row to insert the record present in the query received, the first master device is further configured to:
mark the row dirty; and
update the next record received in the query when the row is marked dirty.

7. A system for multi-master replication, the system comprising:
at least one second master device having a second database at a second replication site, and configured to:
receive at least a row_id of a row and a record present in the query from at least one first master device;
check a conflict based on the row_id received with at least a row in the second database;
wherein if the conflict is detected, the commit fails and an error is displayed, and
wherein if the conflict is not detected, the record is applied at a first database residing at the first master device and the second database simultaneously.

8. The system as claimed in claim 7, wherein updating the next record further comprises:
detecting the row based on the row_id for updating the next record; and
checking whether the row is marked dirty, wherein the row is marked dirty by at least a replica update, and wherein updating the next record is failed when the row is marked dirty; and
update the next record in the row when the row is not marked dirty.

9. The system as claimed in claim 8, wherein upon updating the next record in the row, moving at least a conflict resolution to commit.

10. A method for multi-master replication, the method comprising:
receiving at least one query;
allocating at least a row to insert at least one record present in the query received based on a row_id;
roll back the insert of the at least one record when the record to insert exceeds the row allocated; and
transmitting the row_id and the record present in the query received to at least one device for a conflict check during commit when the record to insert does not exceed the row allocated.

11. The method as claimed in claim 10, wherein the method is a row identification (row_id) based multi-master replication.

12. The method as claimed in claim 10, wherein on receipt of the row to insert the record present in the query received, the method further comprising:
marking the row dirty; and
updating the next record received in the query when the row is marked dirty.

13. The method as claimed in claim 12, wherein updating the next record further comprises:
detecting the row for updating the next record;
checking whether the row is marked dirty, wherein the row is marked dirty by at least a replica update, wherein updating the next record is failed when th row is marked dirty; and
updating the next record in the row when the row is not marked dirty.

14. The method as claimed in claim 13, wherein upon updating the next record in the row, the method further comprises moving at least a conflict resolution to commit.

15. The method as claimed in claim 10, wherein the commit further comprising:
communicating at least a message to the other device, wherein the message comprise at least a row identification (row_id);
checking a conflict based on the row_id from the message communicated with at least the row_id of the other device, wherein the commit fails and an error is displayed when the conflict is detected; and
committing the record when the conflict is not detected.

16. A device comprising:
a processor;
amemory coupled to the processor and configured to store a plurality of instructions that, when executed, cause the processor to:
receive at least one query to insert at least one record in a database;
allocate at least an empty write set for the record received in the query; and
roll back or commit the record based on the conflict determined.

17. A method comprising:
receiving at least one query to insert at least one record in a database;
allocating at least an empty write set for the record received in the query; and
roll back or commit the record based on the conflict determined.
